(19) United States
(12) Patent Application Publication
(10) Pub. No.: US 2014/0075354 A1
(43) Pub. Date: Mar. 13, 2014

(54) APPARATUS AND METHOD FOR PROVIDING USER INTERFACE FOR DATA MANAGEMENT

(71) Applicant: PANTECH CO., LTD., Seoul (KR)

(72) Inventor: Byeong Hyeon KO, Seoul (KR)

(73) Assignee: PANTECH CO., LTD., Seoul (KR)

(21) Appl. No.: 13/973,597

(22) Filed: Aug. 22, 2013

(30) Foreign Application Priority Data
Sep. 7, 2012 (KR) 10-2012-0099106

(51) Int. Cl. G06F 3/0486

(52) U.S. Cl. CPC G06F 3/0486
USPC 715/769

(57) ABSTRACT

Provided is an apparatus and method for providing a user interface for data management that may simplify editing of data files and folders in a mobile terminal through a touch-based operation. The method for providing a user interface for data management, including: displaying an application screen including a first area and a second area on a touch screen display, the first area being configured to display a folder object list including a folder object; displaying a user interface object in the second area; receiving a touch input to relocate the user interface object to the first area; in response to a determination that the touch input corresponds to a touch event for relocating the user interface object to the folder object in the folder object list, changing path information of the user interface object to associate with the folder object.

### CROSS-REFERENCE TO RELATED APPLICATIONS

This application claims priority from and the benefit of Korean Patent Application No. 10-2012-0099106, filed on Sep. 7, 2012, which is hereby incorporated by reference in its entirety for all purposes as if fully set forth herein.

### BACKGROUND

1. Field

Exemplary embodiments of the present invention relate to an apparatus and method for providing a user interface, and more particularly, to an apparatus and method for providing a user interface for editing data files and folders through a touch-based operation.

2. Discussion of the Background

With the advancement of mobile terminals, types of data available through an application executed in a mobile terminal are increasing. Accordingly, there is a need for functions of managing data files for each folder in a mobile terminal, similar to those available in a personal computer (PC).

When a file or folder is selected by a user among multimedia files provided on a display of a mobile terminal, for example, image files, video files, and the like, or folders including multimedia files, the selected file or a file in the selected folder may be executed or read through a related application.

An existing mobile terminal fails to provide a folder or directory edit function for an available file through an application. To edit a folder or directory, execution of a separate application dedicated to edit the folder or directory is needed. Further, editing, for example, moving a file or folder using the method available through the separate application may be unsuitable for a mobile terminal that provides a touch-based user interface. Thus, there is a need for a touch-based user interface for managing content stored in a mobile terminal.

### SUMMARY

Exemplary embodiments of the present invention provide an apparatus and method for providing a user interface for data management in a touch screen-based mobile terminal.

Additional features of the invention will be set forth in the description which follows, and in part will be apparent from the description, or may be learned by practice of the invention.

Exemplary embodiments of the present invention provide a method for providing a user interface for data management, including: displaying an application screen including a first area and a second area on a touch screen display, the first area being configured to display a folder object list including a folder object; displaying a user interface object in the second area; receiving a touch input to relocate the user interface object to the first area; in response to a determination that the touch input corresponds to a touch event for relocating the user interface object to the folder object in the folder object list, changing path information of the user interface object to associate with the folder object.

Exemplary embodiments of the present invention provide a method for providing a user interface for data management, including: displaying an application screen including a first area and a second area on a touch screen display, the first area being configured to display a clipboard for depositing a first user interface object or to display a folder object list including a folder object; displaying a second user interface object in the second area; receiving a touch input to relocate the second user interface object to the first area; in response to a determination that the touch input corresponds to a touch event for depositing the second user interface object in the clipboard, depositing the second user interface object in the clipboard as a first user interface object; and in response to a determination that the touch input corresponds to a touch event for relocating the second user interface object to the folder object in the folder object list, changing path information of the second user interface object to associate with the folder object.

Exemplary embodiments of the present invention provide a non-transitory computer readable storage medium storing one or more programs for instructing a computer, when executed by a processor, to perform: displaying an application screen including a first area and a second area on a touch screen display, the first area being configured to display a folder object list including a folder object; displaying a user interface object in the second area; receiving a touch input to relocate the user interface object to the first area; in response to a determination that the touch input corresponds to a touch event for relocating the user interface object to the folder object in the folder object list, changing path information of the user interface object under the folder object.

Exemplary embodiments of the present invention provide an apparatus to provide a user interface for data management, including: a touch screen display to display an application screen including a first area and a second area, the first area being configured to display a folder object list including a folder object, to display a user interface object in the second area, and to receive a touch input to relocate the user interface object to the first area; and a processor configured to change path information of the user interface object to associate with the folder object in response to a determination that the touch input corresponds to a touch event for relocating the second user interface object to the folder object.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating an apparatus to control a mobile terminal according to an exemplary embodiment of the present invention.

FIG. 2 is a block diagram illustrating an apparatus to control a mobile terminal according to another exemplary embodiment of the present invention.

FIG. 3 through FIG. 9 are flow diagrams illustrating a method of controlling a mobile terminal according to an exemplary embodiment of the present invention.

FIG. 10 is a diagram illustrating an example of the method of FIG. 3 according to an exemplary embodiment of the present invention.

FIG. 11 is a diagram illustrating an example of the method of FIG. 4 according to an exemplary embodiment of the present invention.

FIG. 12 is a diagram illustrating an example of the method of FIG. 5 according to an exemplary embodiment of the present invention.

FIG. 13 is a diagram illustrating an example of the method of FIG. 6 according to an exemplary embodiment of the present invention.

FIG. 14 is a diagram illustrating an example of the method of FIG. 7 according to an exemplary embodiment of the present invention.

FIG. 15 is a diagram illustrating an example of the method of FIG. 9 according to an exemplary embodiment of the present invention.

FIG. 16 is a flowchart illustrating a method of controlling a mobile terminal according to an exemplary embodiment of the present invention.

FIG. 17 is a flowchart illustrating a method of controlling a user interface object of a mobile terminal according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The term “user interface” as used herein may include a user interface object that provides an interaction between a user and a mobile terminal and information about various application programs being run in the mobile terminal.

The term “user interface object” may include any type of graphic element provided on a display and selected by a user. When manipulation for executing a user interface object is input in such a state that the user interface object is selected, a predetermined process may be performed on the corresponding user interface object. The term “user interface object” should be understood in a broadest sense to encompass all types of user interface objects including an icon, a menu button, a tool button, various hyperlinks, and the like.

The term, “mobile terminal”, may refer to various kinds of mobile terminals and apparatuses, and may include all types of information and communication devices and multimedia devices including, for example, a personal digital assistant (PDA), a smart phone, a tablet computer, a personal computer, an international mobile telecommunication 2000 (IMT-2000) terminal, a wideband code division multiple access (WCDMA) terminal, a universal mobile telecommunication service (UMTS) terminal, and the like, and applications of these devices. Further, throughout the specification, an apparatus to control a mobile terminal may refer to an embedded hardware and/or software components configured to control the mobile terminal.

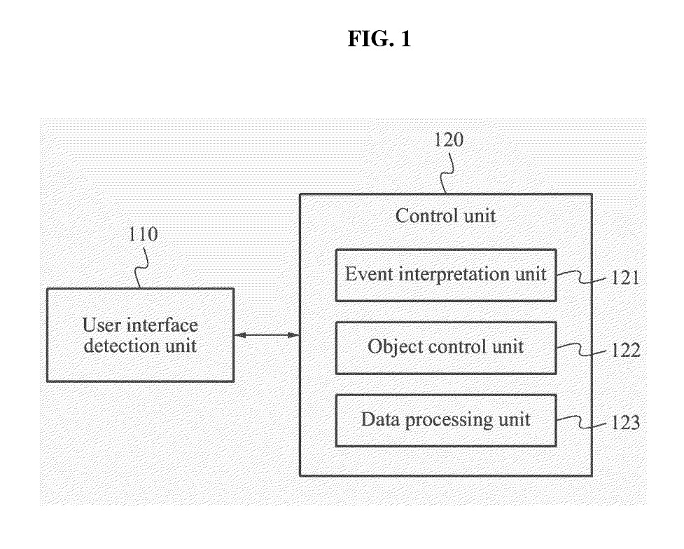

FIG. 1 is a block diagram illustrating an apparatus to control a mobile terminal according to an exemplary embodiment of the present invention.

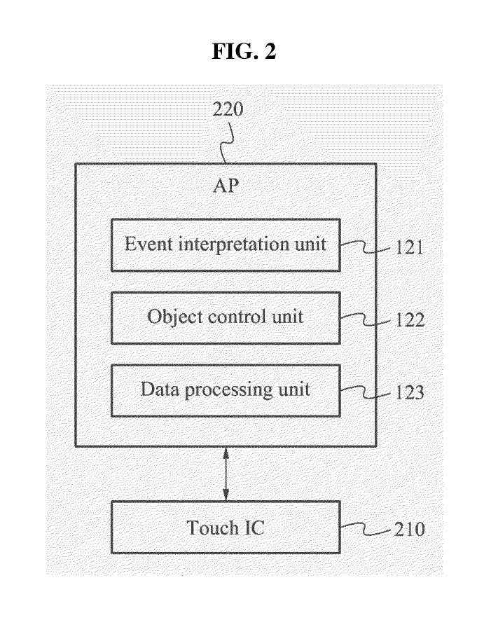

Referring to FIG. 1, the apparatus may include a user interface detection unit 110 and a control unit 120. Further, although not shown in FIG. 2, the apparatus may include hardware components, such as one or more processors, a memory, a touch screen display, a camera, and the like. Also, the units, modules, elements, devices and components of the apparatuses and/or mobile terminals herein described, may include hardware and software, may also include firmware, to perform various operations of the terminal including those described herein, and may be combined or remain separate as described.

The term “application” as used herein may include any application program that can be run by an operation system (OS) of the mobile terminal. Although exemplary embodiments may be described with respect to an Android-based OS or mobile phone, aspects need not be limited thereto such that such features may be applicable to other OSes and/or mobile phones, for example, iOS, Windows Mobile, iPhone, Windows phone, etc.

The user interface detection unit 110 may detect a touch event for a user interface object provided in at least one area on a display.

For example, the user interface detection unit 110 may recognize a touch input for a user interface object placed in a clipboard area on the display or a user interface object included in an image view and edit application, for example, a gallery application of an Android-based mobile phone.

The term “clipboard” may refer to a special memory resource of the mobile terminal, and may be used for copying various types of data, for example, text character stream data, image data, file data, and the like, between different applications or within one application. The term “clipboard area” may refer to a predetermined user interface-based area in which the special memory resource held in the clipboard is provided on the display.

The term “touch recognition area” may correspond to a touch pad or a touch screen. The “touch pad or touch screen” may include a touch integrated circuit (IC), a touch panel, and the like, and may recognize the touch input for the user interface object through the touch IC, for example.

The user interface detection unit 110 may detect an edit action for the user interface object detected from the touch input.

The control unit 120 may interpret a control signal of the touch event for the user interface object detected by the user interface detection unit 110, and may control the user interface object in the at least one area in response to the interpreted control signal of the touch event.

The control unit 120 may update displaying of the user interface object in response to the touch event by determining a type of the edit action for the user interface object detected by the user interface detection unit 110, for example, a move action, a copy action, a paste action, a name change action, and a folder create action, and by carrying out the determined edit action for a data file or a folder corresponding to the user interface object.

The control unit 120 may provide a result of the touch event on the display. The control unit 120 may upgrade displaying of the user interface object in the at least one area in response to the task being performed.

The control unit 120 may include an event interpretation unit 121, an object control unit 122, and a data processing unit 123.

The event interpretation unit 121 may interpret a first touch event and a second touch event detected on the display, and may generate a request signal in response to a control command included in the interpreted touch event. The first touch event and the second touch event may occur in response to a portion of a single touch input. For example, the first touch event may occur in response to the recognition of a touch location of the touch input, and the second touch event may occur in response to the recognition of a drag action of the touch input, e.g., a dragging direction, the end point of the drag action, and the like.

The first touch event may include a selection signal for selecting at least one first user interface object, and the second touch event may include a control signal for controlling the at least one first user interface object selected.

The selection signal may be used to select the first user interface object including a graphic element provided on the display and selected by a user. The control signal may be used to give a command for an edit action to the selected graphic element, such as a move action, a copy action, a paste action, a name change action, and a folder create action.

A first area and a second area may be displayed on the display. The first area may include at least one first user interface object corresponding to data information or data group information placed on the clipboard, and the second area may include at least one second user interface object corresponding to data information or data group information stored in the mobile terminal.

The event interpretation unit 121 may determine a type of the edit action for the user interface object detected by the user interface detection unit 110, and may transmit a request signal to the object control unit 122 to request processing of the edit action.

The object control unit 122 may receive the request signal from the event interpretation unit 121, may perform a task from the control command for the user interface object in response to the request signal, and may determine whether data processing involved in the task will be performed. If the data processing is determined to be performed, the object control unit 122 may generate a data processing request signal and may transmit the generated data processing request signal to the data processing unit 123.

The data processing unit 123 may receive the data processing request signal from the object control unit 122, and may execute an operation corresponding to the received data processing request signal.

The object control unit 122 may perform the task from the control command for the user interface object, and if the data processing involved in the task is determined to be executed in a clipboard cache or a data scanner, the data processing unit 123 may execute the data processing.

For example, if the touch event corresponds to a path change event for changing a path to a determined folder of an image application, for example, a gallery application of an Android-based phone, the event interpretation unit 121 may interpret the touch event to be the path change event, and may transmit the request signal to the object control unit 122 in response to the control command included in the control signal of the touch event.

The object control unit 122 may receive the request signal from the event interpretation unit 121, may change the path in response to the request signal in order to display the user interface object, and may determine whether data processing involved in the path change to be performed. If the data processing is determined to be performed, the object control unit 122 may generate a data processing request signal, and may transmit the generated data processing request signal to the data processing unit 123 to request the data processing.

The data processing unit 123 may receive the data processing request signal from the object control unit 122, and may execute an operation corresponding to the received data processing request signal. Here, the term “operation” may refer to a series of procedures including, e.g., moving, copying, creating of data or a folder, and the like, for changing a path of a data file in a clipboard or data scanner in response to an edit event or edit action.

The data processing unit 123 may generate return information of the operation corresponding to the data processing request signal, and may transmit the generated return information to the object control unit 122. The object control unit 122 may receive the return information from the data processing unit 123, and may transmit callback information to the event interpretation unit 121 in response to the received return information. The event interpretation unit 121 may receive the callback information from the object control unit 122, and may control displaying of the user interface object in an area in response to the received callback information.

The apparatus for controlling a mobile terminal may further include a data cache (not shown) to store path information and/or header information of the user interface object placed on the clipboard (not shown). The data processing unit 123 may execute the operation corresponding to the data processing request signal, for example, a series of procedures for changing the stored path information.

The apparatus for controlling a mobile terminal may further include a data scanner (not shown) to scan data information included in the mobile terminal and to store and maintain the scanned data information temporarily. The data processing unit 123 may execute the operation corresponding to the data processing request signal, for example, a series of procedures for scanning the data information.

According to the exemplary embodiments of the present invention, a series of procedures for changing a data path may be executed through the touch event for moving the first user interface object corresponding to data information or data group information placed on the clipboard of the first area to a second user interface object corresponding to data information or data group information included in the second area.

Although this exemplary embodiment shows the first area and the second area being displayed concurrently such that the first area and the second area are distinguished from one another, the present invention is not limited thereto. For example, the first area may be displayed after the touch event for the second area is completed. Various modifications, changes, and alterations may be implemented depending on a type of the touch event or an edit action.

FIG. 2 is a block diagram illustrating an apparatus to control a mobile terminal according to another exemplary embodiment of the present invention.

Referring to FIG. 2, the apparatus may include a touch integrated chip (IC) 210 and an application processor (AP) 220.

The touch IC 210 may recognize a touch input on a touch pad or a touch screen provided in the apparatus. The touch IC 210 may store, in a memory, a touch location determined relative to a touch sensor of the touch IC 210 and a key event for the touch input. The touch location may include coordinates of the touch location and an index of the touch sensor.

The AP 220 may interpret the touch location acquired through the touch IC 210 to generate a touch event, and may apply the generated touch event to an application.

The AP 220 may include the event interpretation unit 121, the object control unit 122, and the data processing unit 123 of FIG. 1.

The event interpretation unit 121 may interpret a first touch event and a second touch event detected in an area on a display, may generate a request signal in response to a control command included in the interpreted touch event, may determine a type of the touch event or an edit action for a user interface object, and may transmit the request signal to the object control unit 122 to request processing of the touch event or the edit action.

The object control unit 122 may receive the request signal from the event interpretation unit 121, may perform a task from the control command for the user interface object in response to the request signal, and may determine whether data processing involved in the task is to be performed. If the data processing is determined to be performed, the object control unit 122 may generate a data processing request signal and may transmit the generated data processing request signal to the data processing unit 123.

The data processing unit 123 may receive the data processing request signal from the object control unit 122, and may execute an operation corresponding to the data processing request signal.

The data processing unit 123 may generate return information of the operation corresponding to the data processing request signal, and may transmit the generated return information to the object control unit 122. The object control unit 122 may receive the return information from the data processing unit 123, and may transmit callback information to the event interpretation unit 121 in response to the return information. The event interpretation unit 121 may receive the callback information from the object control unit 122, and may control displaying of the user interface object in the at least one area in response to the callback information.

In an example, the first touch event may include a selection signal for selecting at least one first user interface object, and the second touch event may include a control signal for controlling the at least one first user interface object selected. The second area may include at least one second user interface object corresponding to data group information.

The event interpretation unit 121 may interpret the control signal, and may generate the request signal for moving the at least one first user interface object to the second user interface object in response to the control command included in the interpreted control signal.

As described in detail below, if an application being run in the mobile terminal corresponds to an image application, e.g., a gallery application of an Android-based phone, and the first user interface object corresponds to a thumbnail of an image on the clipboard and the second user interface object corresponds to a folder of the image application, the event interpretation unit 121 may interpret, from the touch event, the control command included in the control signal to be a control command for a path change event or a move action e.g., a path change or a move of image data corresponding to the thumbnail of the image on the clipboard into the folder of the image application.

The object control unit 122 may receive the generated request signal from the event interpretation unit 121, and may change data group information corresponding to the first user interface object to data group information corresponding to the second user interface object in response to the request signal.

The event interpretation unit 121 may interpret the control signal, and if the interpreted control signal includes a control command for creating a new second user interface object and moving at least one first user interface object to the new second user interface object, the event interpretation unit 121 may generate the request signal in response to the control command.

If an application being run in the mobile terminal corresponds to an image application, e.g., a gallery application of an Android-based phone, iOS®-based phone, and the like, and the first user interface object corresponds to a thumbnail of an image on the clipboard and the second user interface object corresponds to a new folder of the image application, the event interpretation unit 121 may interpret, from the touch event, the control command included in the control signal to be a control command for a path change event or a move action, e.g., a path change of image data corresponding to the thumbnail of the image on the clipboard into the new folder of the image application.

The object control unit 122 may receive the generated request signal from the event interpretation unit 121, and may change data group information of the first user interface object to data group information of the new second user interface in response to the request signal.

In another example, the first touch event may include a selection signal for selecting at least one first user interface object and the second touch event may include a control signal for controlling the at least one first user interface object selected. The second area may include at least one second user interface object corresponding to data information.

The event interpretation unit 121 may interpret the control signal, and if the interpreted control signal includes a control command for moving the at least one first user interface object to the second area, the event interpretation unit 121 may generate the request signal in response to the control command.

The object control unit 122 may receive the generated request signal from the event interpretation unit 121, and may change data group information of the first user interface object to data group information of the at least one second user interface object in response to the request signal.

The data processing unit 123 may execute the operation on path information stored in a data cache.

In still another example, the first touch event may include a selection signal for selecting at least one first user interface object, and the second touch event may include a control signal for scrolling the at least one first user interface object selected.

In yet another example, the first touch event may include a selection signal for selecting at least one second user interface object, and the second touch event may include a control signal for controlling the at least one second user interface object selected. The first area may include at least one first user interface object corresponding to data group information placed on the clipboard.

The event interpretation unit 121 may interpret the control signal, and if the interpreted control signal includes a control command for moving the at least one second user interface object to the first user interface object, the event interpretation unit 121 may generate a request signal in response to the control command.

The object control unit 122 may receive the generated request signal from the event interpretation unit 121, and may change data group information corresponding to the second user interface object to data group information corresponding to the first user interface object in response to the request signal.

In further another example, the first touch event may include a selection signal for selecting at least one second user interface object and the second touch event may include a control signal for controlling the at least one second user interface object selected. The first area may include at least one first user interface object corresponding to data group information arranged in a certain direction. According to aspects of the invention, the first area may display file folders as the data group information and may not serve as the clipboard if multiple first user interface objects in the second area are selected or if a predetermined or set condition is satisfied.

The event interpretation unit 121 may interpret the control signal, and if the interpreted control signal includes a control command for generating a new first user interface object and moving the at least one second user interface object to the new first user interface object, the event interpretation unit 121 may generate a request signal in response to the control command.

The object control unit 122 may receive the generated request signal from the event interpretation unit 121, and may change data group information corresponding to the second user interface object to data group information corresponding to the first user interface object in response to the request signal.

As another example, the first touch event may include a selection signal for selecting at least one second user interface object, and the second touch event may include a control signal for controlling the at least one second user interface object selected.

The event interpretation unit 121 may interpret the control signal, and if the interpreted control signal includes a control command for moving the at least one second user interface object to the first area, the event interpretation unit 121 may generate a request signal in response to the control command.

The object control unit 122 may receive the generated request signal from the event interpretation unit 121, and may change data group information corresponding to the second user interface object to data group information corresponding to at least one first user interface object in response to the request signal.

The data processing unit 123 may execute the operation on path information stored in a data cache.

As still another example, the first touch event may include a selection signal for selecting at least one second user interface object, and the second touch event may include a control signal for scrolling the second user interface object.

As yet another example, the first touch event may include a selection signal for selecting a criterion for re-arranging the user interface object included in at least one area on the display, and the second touch event may include a control signal for controlling arrangement of the user interface object in the at least one area on the display based on the selected criterion.

The term “clipboard area” or “first area” used herein may refer to an area in which at least one first user interface object corresponding to data information or data group information placed on the clipboard is provided on the display. The term “gallery area” or “second area” may refer to an area in which at least one second user interface object corresponding to data information or data group information stored in the mobile terminal is provided on the display.

The term “folder object” used herein may refer to a user interface object corresponding to data group information provided on the display. The term “folder object list” may refer to a plurality of folder objects provided on the display.

The apparatus for controlling a mobile terminal may include the user interface detection unit 110, the event interpretation unit 121, and the object control unit 122.

The user interface detection unit 110 may detect a touch event for a user interface object placed on a clipboard area on a display.

The event interpretation unit 121 may determine whether a touch action of the detected touch event is a drag action for dragging the user interface object to a gallery area on the display or a scroll action for scrolling through the first user interface object in the clipboard area, and may generate a request signal to request processing of the touch event.

The object control unit 122 may receive the generated request signal from the event interpretation unit 121, and if the touch action is determined to be the drag action and a folder object matches the end point of the drag action, the object control unit 122 may perform a task from a control command for moving the user interface object to the determined folder object in response to the request signal.

If the touch action is determined to be the scroll action, the object control unit 122 may perform a task from a control command for scrolling the first user interface object in the clipboard area.

If the touch action is determined to be the drag action and a folder object list is absent in the gallery area, the object control unit 122 may perform a task from a control command for moving the user interface object into the gallery area. If the touch action is determined to be the drag action, the folder object list is present in the gallery area, and the end point of the drag action does not match a folder object in the gallery area, the object control unit 122 may perform a task from a control command for moving the user interface object to a new folder object and the new folder object is created in the gallery area.

The user interface detection unit 110 may detect a touch event for a user interface object provided in the gallery area on the display.

The event interpretation unit 121 may determine whether a touch action of the detected touch event is a drag action for dragging the user interface object to the clipboard area on the display or a scroll action for scrolling the user interface object in the gallery area, and may generate a request signal to request for processing of the touch event.

The object control unit 122 may receive the generated request signal from the event interpretation unit 121, and if the touch action is determined to be the drag action and a folder object in the clipboard area is determined to match the end point of the drag action, the object control unit 122 may perform a task from a control command for moving the user interface object to the folder object. If the touch action is determined to be the scroll action, the object control unit 122 may perform a task from a control command for scrolling the user interface object in the gallery area.

If the end point of the drag action does not match a folder object in the clipboard area, the object control unit 122 may perform a task from a control command for moving the user interface object to the clipboard area.

Hereinafter, a method of controlling a mobile terminal will be described in detail.

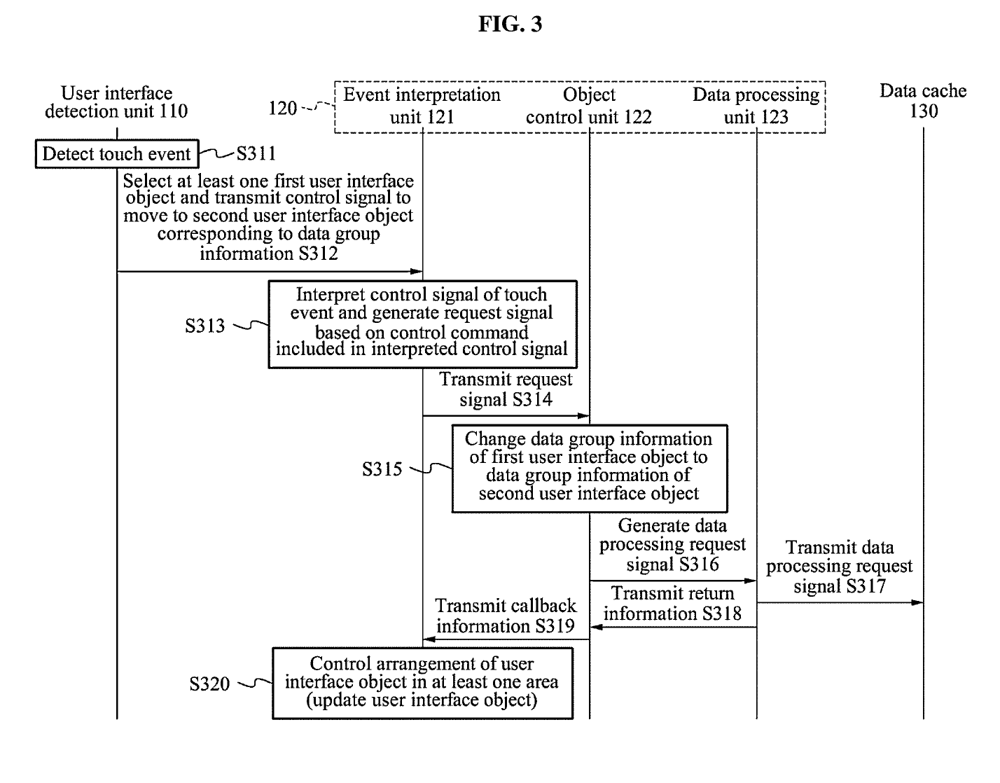

FIG. 3 through FIG. 9 are flow diagrams illustrating a method of controlling a mobile terminal according to an exemplary embodiment of the present invention. FIG. 3 through FIG. 9 will be described as if performed by the apparatus shown in FIG. 1, but is not limited as such.

Referring to FIG. 3, in operation S311, the user interface detection unit 110 may detect a touch event for a user interface object provided in at least one area on a display.

The areas on the display may include a first area and a second area. The first area may include at least one first user interface object corresponding to data information or data group information placed on a clipboard, and the second area may include at least one second user interface object corresponding to data information or data group information stored in the mobile terminal.

In operation S312, the user interface detection unit 110 may select at least one first user interface object, and may transmit, to the event interpretation unit 121 of the control unit 120, the detected touch event including a control signal for moving the first user interface object to the second user interface object corresponding to data group information.

In operation S313, the event interpretation unit 121 of the control unit 120 may interpret a control signal of a second touch event in relation to the first touch event detected in an area on the display, and may generate a request signal in response to the control command included in the interpreted control signal.

In operation S314, the event interpretation unit 121 may transmit the generated request signal to the object control unit 122.

In operation S315, the object control unit 122 may receive the request signal from the event interpretation unit 121, and may perform a task from the control command for the user interface object in response to the request signal. The object control unit 122 may change data group information of the first user interface object to data group information of the second user interface object in response to the control command.

In operation S316, the object control unit 122 may generate a data processing request signal to request the data processing.

In operation S317, the data processing unit 123 may receive the generated data processing request signal from the object control unit 122, and may execute an operation corresponding to the received data processing request signal. The data processing unit 123 may control the data cache 130 to execute a series of procedures for changing path information in response to the data processing request signal. During the procedures, the data cache 130 stores path information and/or header information of the user interface object placed on the clipboard.

In operation S318, the data processing unit 123 may generate return information of the operation corresponding to the data processing request signal, and may transmit the generated return information to the object control unit 122.

In operation S319, the object control unit 122 may receive the return information from the data processing unit 123, and may transmit callback information to the event interpretation unit 121 in response to the received return information.

In operation S320, the event interpretation unit 121 may control displaying of the user interface object in the at least one area in response to the received callback information.

Accordingly, a series of procedures for changing a data path may be executed through the touch event for moving the first user interface object corresponding to data information or data group information placed on the clipboard of the first area to at least one second interface object corresponding to data information or data group information included in the second area.

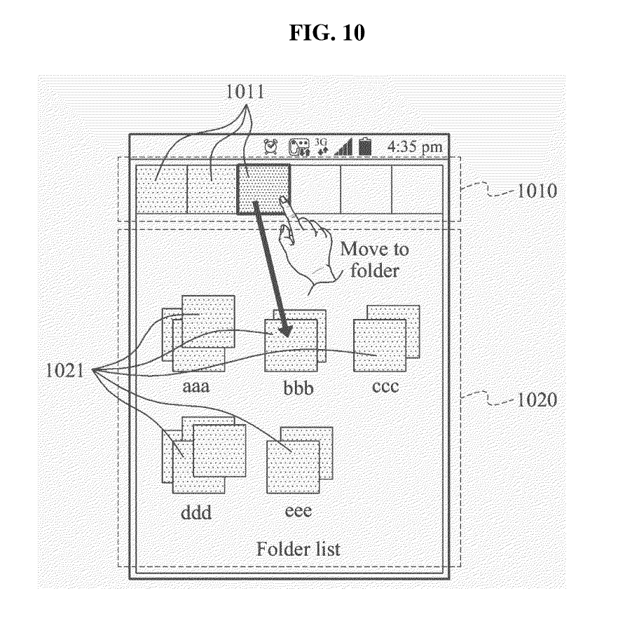

Hereinafter, an example of the method of FIG. 3 will be described with reference to FIG. 10.

FIG. 10 is a diagram illustrating an example of the method of FIG. 3 according to an exemplary embodiment of the present invention.

Referring to FIG. 10, the display of the mobile terminal may include more than one area displayed on a touch screen. One area may be distinguished from another area, and the more than one area may include a first area 1010 and a second area 1020. The first area 1010 may include at least one first user interface object 1011 corresponding to data information or data group information placed on the clipboard. The first area 101 may be a user interface area for providing a clipboard to store a piece of data temporarily or providing a list to display one or more user interface objects, e.g., a folder object list including folder objects corresponding to file folders in which pieces of data can be stored or relocated. The second area 1020 may include at least one second user interface object 1021 corresponding to data information or data group information stored in the mobile terminal.

The first touch event may correspond to a selection signal for selecting the at least one first user interface object 1011 in the first area 1010, and the second touch event may correspond to a control signal for controlling the selected first user interface object 1011. For example, the first touch event may correspond to a touch event or touch action for touching and selecting the first user interface object 1011, and the second touch event may correspond to a touch event or touch action for dragging and dropping the selected first user interface object 1011 to one of the second user interface object 1021.

The user interface detection unit 110 may detect an edit action for the user interface object detected from the touch input. The control unit 120 may interpret a control signal for the user interface object based on the touch event detected by the user interface detection unit 110, and may control the user interface object in the at least one area in response to the interpreted control signal of the touch event.

If the application being run in the mobile terminal corresponds to an image application, for example, a gallery application of an Android-based phone, and the touch event corresponds to a path change event or a move action for dragging and dropping the first user interface object 1011 corresponding to an image file on the clipboard to the second user interface object 1012 corresponding to an image folder object of the image application, the control unit 120 may interpret and determine the touch event to be the path change event or the move action for selecting the first user interface object 1011 and dragging and dropping the selected first user interface object 1011 into the second user interface object 1012, and may control displaying of the user interface object in response to the path change event or the move action.

The user interface detection unit 110 may transmit, to the event interpretation unit 121 of the control unit 120, the touch event for changing a path of the first user interface object 1011 to the determined second user interface object 1021. The event interpretation unit 121 of the control unit 120 may interpret the touch event, may generate a request signal in response to a control command included in the interpreted control signal of the touch event, and may transmit the generated request signal to the object control unit 122.

While the drag-and-drop touch event continues, the event interpretation unit 121 may move coordinates of the first user interface object 1011 to match coordinates of a touch point of the first user interface object 1011. The control unit 120 may animate the first user interface object 1011 to provide a visual interface, indicating the touch event as valid.

Also, the event interpretation unit 121 may determine the validity of the touch event. For example, if an end point (“drop point”) of the second touch event as a drag-and-drop touch event for the first user interface object 1011 in the image application of FIG. 10 is not corresponding to a second user interface object or not corresponding to another location of the second area 1020 in which the second user interface object 1021 is included, the event interpretation unit 121 may determine the touch event is invalid and may move the first user interface object 1011 back to the original location in the first area 1010.

If it is determined that the touch event is valid, the object control unit 122 may change data group information, e.g., folder information, of the first user interface object 1011 to data group information, e.g., folder information of the second user interface object 1021. The object control unit 122 may change a folder path of the first user interface object 1011.

The object control unit 122 may determine whether data processing involved in the task from the control command is to be performed, and if the data processing is determined to be performed, the object control unit 122 may generate a data processing request signal to request the data processing. The data processing unit 123 may control the data cache 130 to execute a series of procedures for changing path information in response to the received data processing request signal.

The data cache 130 may store path information and/or header information of the user interface object placed on the clipboard. In FIG. 10, the data cache 130 may store paths and thumbnails of images on the clipboard. Also, the data cache 130 may be in a form of a hash table, and may store the path as a key and the thumbnail as a value. To add or delete images, the data cache 130 may search for an image using a path name of the key and may add or delete the found image.

The data processing unit 123 may generate return information of the operation corresponding to the data processing request signal, and may transmit the generated return information to the object control unit 122. The object control unit 122 may receive the return information from the data processing unit 123, and may transmit callback information to the event interpretation unit 121 in response to the received return information.

The event interpretation unit 121 may update displaying of the user interface object in at least one area among areas displayed on the screen in response to the received callback information.

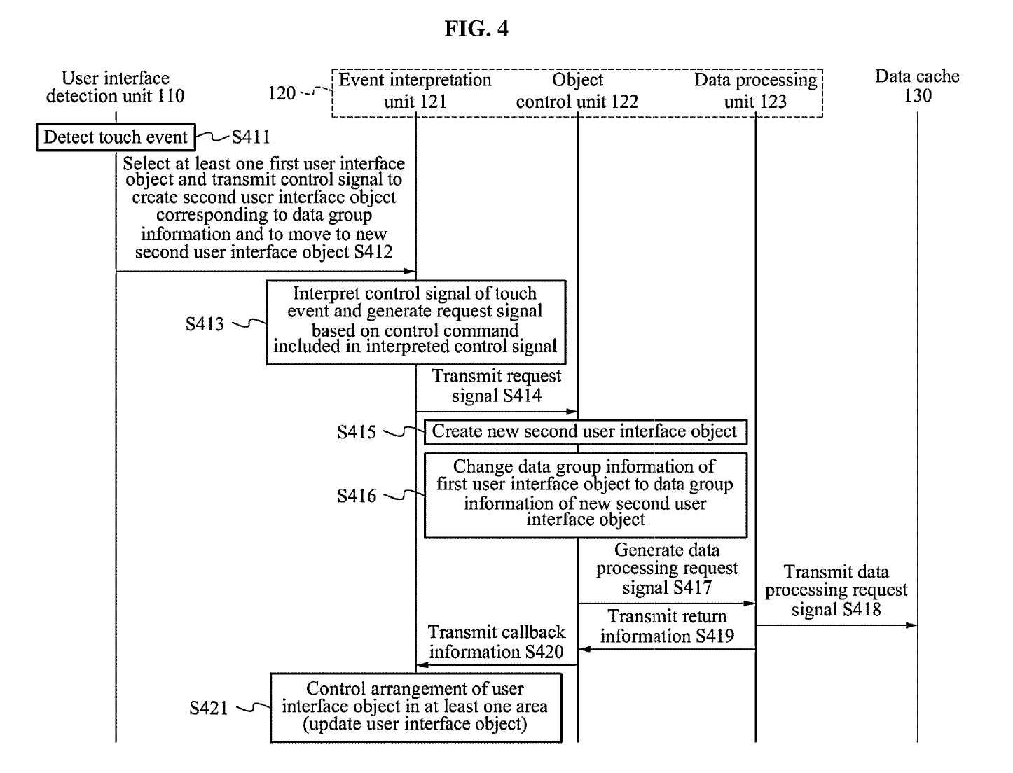

FIG. 4 is a flow diagram illustrating a method of controlling a mobile terminal according to another exemplary embodiment of the present invention.

Referring to FIG. 4, in operation S411, the user interface detection unit 110 may detect a touch event for a user interface object provided in at least one area on a display.

The areas on the display may include a first area and a second area. The first area may include at least one first user interface object corresponding to data information or data group information placed on a clipboard, and the second area may include at least one second user interface object corresponding to data information or data group information stored in the mobile terminal.

In operation S412, the user interface detection unit 110 may select the at least one first user interface object, and may transmit, to the event interpretation unit 121 of the control unit 120, the detected touch event including a control signal for creating a new second user interface object corresponding to data group information and for moving the selected first user interface object to the new second user interface object.

In operation S413, the event interpretation unit 121 of the control unit 120 may interpret a control signal of a second touch event in relation to the first touch event detected in an area, e.g., a location corresponding to a first user interface object in the first area, on the display, and may generate a request signal in response to a control command included in the interpreted control signal.

In operation S414, the event interpretation unit 121 may transmit the generated request signal to the object control unit 122.

In operations S415 and S416, the object control unit 122 may receive the request signal from the event interpretation unit 121, and may perform a task from the control command for the user interface object in response to the request signal. The object control unit 122 may create a new second interface object and may change data group information of the first user interface object to data group information of the new second user interface object.

In operation S416, the object control unit 122 may determine whether execution of data processing involved in the task from the control command is to be performed in a clipboard cache or data cache or a data scanner, and if the data processing is determined to be performed, the object control unit 122 may generate a data processing request signal to request the data processing.

In operation S417 and S418, the data processing unit 123 may receive the generated data processing request signal from the object control unit 122, and may execute an operation corresponding to the received data processing request signal. The data processing unit 123 may control the data cache 130 to execute a series of procedures for changing path information, in response to the data processing request signal, in which the data cache 130 stores path information and/or header information of the user interface object placed on the clipboard.

In operation S419, the data processing unit 123 may generate return information of the operation corresponding to the data processing request signal, and may transmit the generated return information to the object control unit 122.

In operation S420, the object control unit 122 may receive the return information from the data processing unit 123, and may transmit callback information to the event interpretation unit 121 in response to the received return information.

In operation S421, the event interpretation unit 121 may control displaying of the user interface object in the at least one area in response to the received callback information.

Accordingly, a series of procedures for changing a data path may be executed through the touch event for moving the first user interface object corresponding to data information or data group information placed on the clipboard of the first area to the new second user interface object corresponding to data information or data group information stored in the second area.

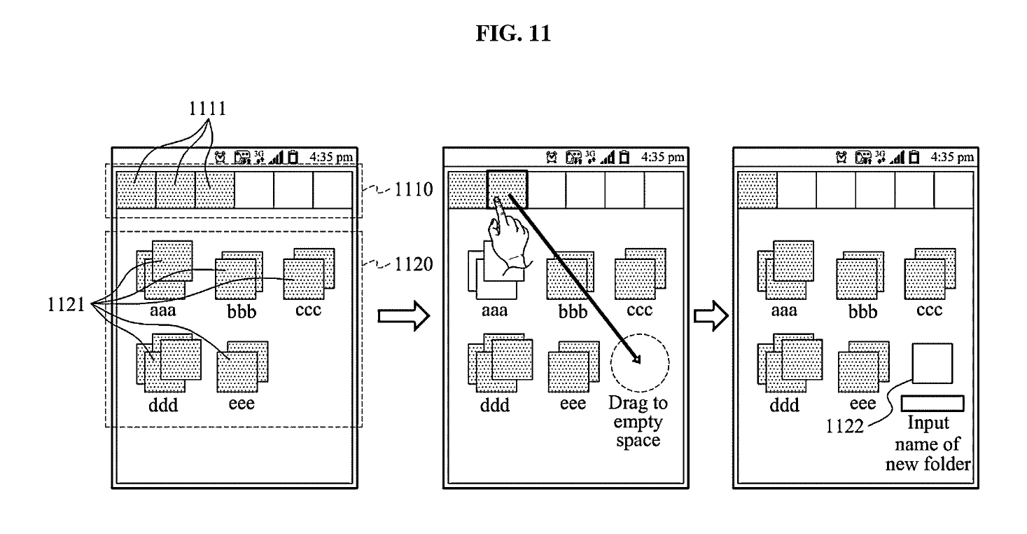

Hereinafter, an example of the method of FIG. 4 will be described with reference to FIG. 11.

FIG. 11 is a diagram illustrating an example of the method of FIG. 4 according to an exemplary embodiment of the present invention.

Referring to FIG. 11, the display of the mobile terminal may include at least one or multiple areas. The multiple areas may be distinguished from one another, and may include a first area 1110 and a second area 1120. The first area 1110 may retrieve a clipboard for storing data files temporarily and display the clipboard in the first area 1110. The first area 1110 may include at least one first user interface object 1111 corresponding to data information or data group information placed on the clipboard. The second area 1120 may display data folders and/or data files of a selected data folder. The second area 1120 may include at least one second user interface object 1121 corresponding to data information or data group information stored in the mobile terminal. For example, the second user interface may display image files and image file folders stored in a gallery folder. If a second user interface object ‘aaa’ 1121 is selected the second area 1120 may display files and subfolders of the second user interface object ‘aaa’ 1121. If a touch input for loading an upper folder is received, the upper folder may be loaded on the second area 1120. For example, a drag input from the left to the right in the second area 1120 may correspond to the touch input for loading the upper folder.

The first touch event may correspond to a selection signal for selecting the at least one first user interface object 1111 in the first area 1110, and the second touch event may correspond to a control signal for controlling the selected first user interface object 1111. For example, the first touch event may correspond to a touch event or touch action for touching and selecting the at least one first user interface object 1111, and the second touch event may correspond to a touch event or touch action for dragging and dropping the selected first user interface object 1111 to an empty area in which the second user interface object 1121 is not located. In order to select more than one first user interface object 1111, a multi-touch action on the more than one first user interface object 1111 or a consecutive touches may be received on the more than one first user interface object 1111.

The user interface detection unit 110 may detect an edit action for the user interface object detected from the touch input. The control unit 120 may interpret a control signal for the user interface object based on the touch event detected by the user interface detection unit 110, and may control the user interface object in the at least one area in response to the interpreted control signal of the touch event.

If an application being run in the mobile terminal corresponds to an image application, e.g., a gallery application of an Android-based phone, and the touch event corresponds to a folder create and path change event or a move action for dragging and dropping the first user interface object 1111 in the first area 1110 corresponding to an image file of the clipboard to the empty area in which the second user interface object 1121 corresponding to a folder object of the image application is absent, the control unit 120 may interpret and determine the touch event as the folder create and path change event or the move action for selecting the first user interface object 1111 and dragging and dropping the selected first user interface object 1111, and may control displaying of the user interface object in response to the folder create and path change event or the move action.

For example, a process for creating a folder in an android-based mobile terminal is as follows:

File direct=new File(Environment.getExternalStorageDirectory( )+“/folder_name”);

An example of an operational process for creating a new folder and moving a user interface object to the new folder in an android-based mobile terminal is as follows:

File from=new File(“file folder path”, “name of file to be moved”);

File to=new File(“destination folder path”, “name of file to be moved”);

from.renameTo(to); //file path change

The user interface detection unit 110 may transmit, to the event interpretation unit 121 of the control unit 120, the touch event for changing a path from the first user interface object 1111 to the second user interface object 1121. The event interpretation unit 121 of the control unit 120 may interpret the touch event, may generate a request signal in response to a control command included in the interpreted control signal of the touch event, and may transmit the generated request signal to the object control unit 122.

While the drag-and-drop touch event continues, the event interpretation unit 121 may move coordinates (“location”) of the first user interface object 1111 to match coordinates of a touch point of the first user interface object 1111. The control unit 120 may animate the first user interface object 1111 to provide a visual interface indicating the touch event as valid.

Also, the event interpretation unit 121 may determine the validity of the touch event. For example, if the end point of the second touch event as a drag-and-drop touch event of the first user interface object 1111 is not located in the second area of the image application of FIG. 11, the event interpretation unit 121 may determine the touch event as invalid and may relocate the first user interface object 1111 to the previous location.

If the touch event is determined as valid, the object control unit 122 may create a new second user interface object 1122 and may change folder information of the first user interface object 1111 to folder information of the new second user interface object 1122. The object control unit 122 may create a new folder in the second area 1120 for the first user interface object 1111 and may change a path to the new folder.

The object control unit 122 may determine whether an execution of data processing involved in the path change is to be performed in a data cache or a data scanner, and if the data processing is determined to be performed, the object control unit 122 may generate a data processing request signal to request the data processing. The data processing unit 123 may control the data cache 130 to execute a series of procedures for changing path information stored in the data cache 130 in response to the received data processing request signal.

The data processing unit 123 may generate return information of the operation corresponding to the data processing request signal, and may transmit the generated return information to the object control unit 122. The object control unit 122 may receive the return information from the data processing unit 123, and may transmit callback information to the event interpretation unit 121 in response to the received return information.

The event interpretation unit 121 may update displaying of the user interface object in the at least one area in response to the received callback information.

Accordingly, an interface may be provided through the apparatus for controlling a mobile terminal by creating the folder 1122 in the second area 1120, by copying the first user interface object 1111 for the touch event in the clipboard of the first area 1110, by pasting the copied first user interface object 1111 into the new folder 1122, and by removing the first user interface object 1111 from the clipboard of the first area 1110.

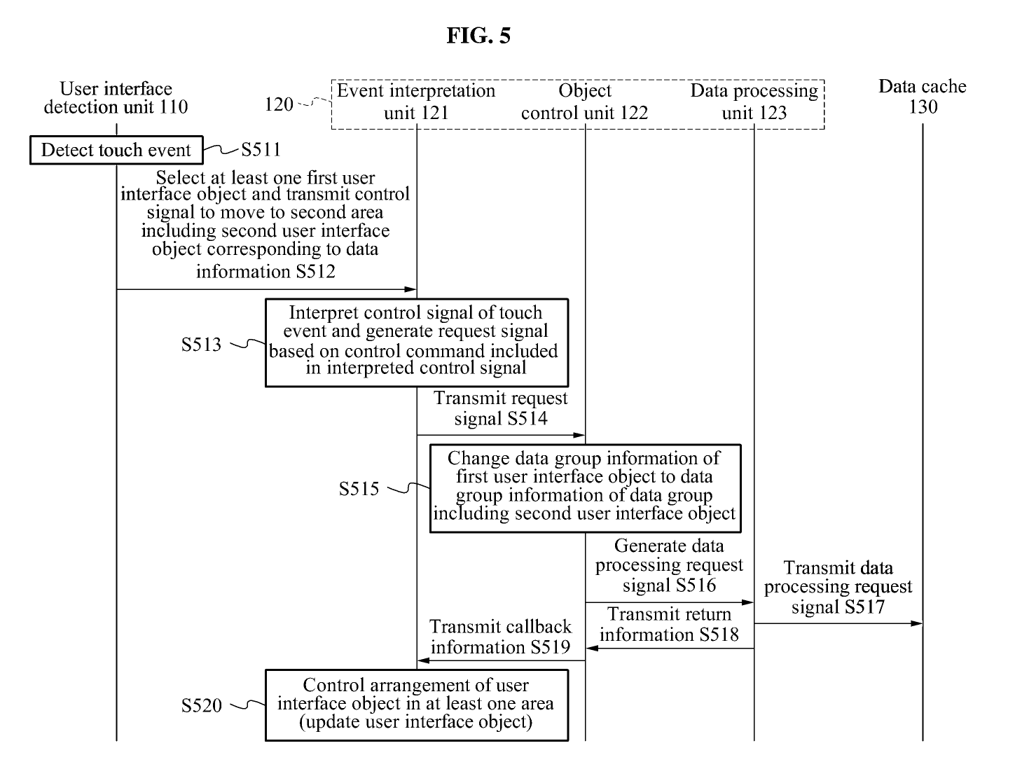

FIG. 5 is a flow diagram illustrating a method of controlling a mobile terminal according to still another exemplary embodiment of the present invention.

The method of FIG. 5 is similar to that of FIG. 3 aside from the second user interface object corresponding to data information, rather than data group information. Referring to FIG. 5, in operation S511, the user interface detection unit 110 may detect a touch event for a user interface object provided in at least one area on a display.

The areas on the display may include a first area and a second area. The first area may include at least one first user interface object corresponding to data information or data group information placed on a clipboard, and the second area may include at least one second user interface object corresponding to data information stored in the mobile terminal.

In operation S512, the user interface detection unit 110 may select at least one first user interface object, and may transmit, to the event interpretation unit 121 of the control unit 120, the detected touch event including a control signal for moving the first user interface object to the second area including the second user interface object corresponding to data information.

In operation S513, the event interpretation unit 121 of the control unit 120 may interpret a control signal of a second touch event in relation to the first touch event detected in an area on the display, and may generate a request signal in response to the control command included in the interpreted control signal.

In operation S514, the event interpretation unit 121 may transmit the generated request signal to the object control unit 122.

In operation S515, the object control unit 122 may receive the request signal from the event interpretation unit 121, and may perform a task from the control command for the user interface object in response to the request signal. The object control unit 122 may change data group information of the first user interface object to data group information of a data group including the at least one second user interface object in response to the control command. For example, the data group including the at least one second user interface object may be a data folder including one or more data files corresponding to the second user interface object.

In operation S516, the object control unit 122 may generate a data processing request signal to request the data processing.

In operation S517, the data processing unit 123 may receive the generated data processing request signal from the object control unit 122, and may execute an operation corresponding to the received data processing request signal. The data processing unit 123 may control the data cache 130 to execute a series of procedures for changing path information in response to the data processing request signal. During the procedures, the data cache 130 stores path information and/or header information of the user interface object placed on the clipboard.

In operation S518, the data processing unit 123 may generate return information of the operation corresponding to the data processing request signal, and may transmit the generated return information to the object control unit 122.

In operation S519, the object control unit 122 may receive the return information from the data processing unit 123, and may transmit callback information to the event interpretation unit 121 in response to the received return information.

In operation S520, the event interpretation unit 121 may control displaying of the user interface object in the at least one area in response to the received callback information.

Accordingly, a series of procedures for changing a data path may be executed through the touch event for moving the first user interface object corresponding to data information or data group information placed on the clipboard of the first area to a data group including at least one second interface object corresponding to data information displayed in the second area.

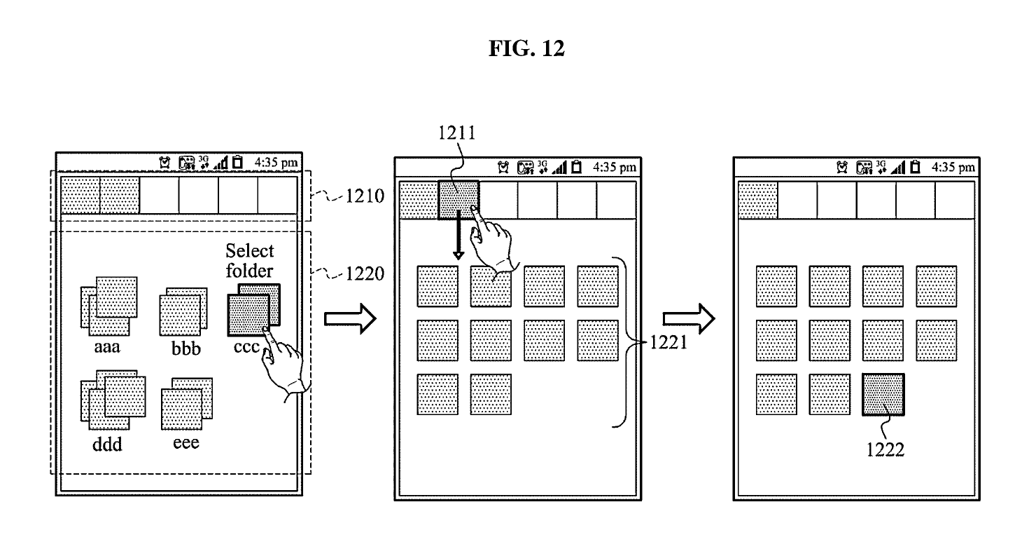

Hereinafter, an example of the method of FIG. 5 is described with reference to FIG. 12.

FIG. 12 is a diagram illustrating an example of the method of FIG. 5 according to an exemplary embodiment of the present invention.

Referring to FIG. 12, the display of the mobile terminal may include more than one area. The areas displayed on the display may be distinguished from one another, and may include a first area 1210 and a second area 1220. The first area 1210 may include at least one first user interface object 1211 corresponding to data information or data group information placed on the clipboard. The second area 1220 may include at least one second user interface object 1222 corresponding to information stored in the mobile terminal.

The first touch event may correspond to a selection signal for selecting the at least one first user interface object 1211 in the first area 1210, and the second touch event may correspond to a control signal for controlling the selected first user interface object 1211. For example, the first touch event may correspond to a touch event or touch action for touching and selecting the first user interface object 1211, and the second touch event may correspond to a touch event or touch action for dragging and dropping the selected first user interface object 1211 to the second area 1220.

For example, if an application being run in the mobile terminal corresponds to an image application, e.g., a gallery application of an Android-based phone, and the touch event corresponds to a path change event or a move action for dragging and dropping the first user interface object 1211 in the first area 1210 corresponding to an image file on the clipboard to the second area 1220 corresponding to a data area in a folder ‘ccc’ of the image application, the control unit 120 may interpret and determine the touch event to be the path change event or the move action for selecting the first user interface object 1211 and dragging and dropping the selected first user interface object 1211 to the second area 1220 corresponding to the folder ‘ccc’, and may control displaying of the user interface object in response to the path change event or the move action.

The user interface detection unit 110 may transmit, to the event interpretation unit 121 of the control unit 120, the touch event for changing a path of the first user interface object 1211 to data group information of the data group, the folder ‘ccc’, including the second user interface object 1221. The event interpretation unit 121 of the control unit 120 may interpret the touch event, may generate a request signal in response to a control command included in the control signal of the interpreted touch event, and may transmit the generated request signal to the object control unit 122.

While the drag-and-drop touch event continues, the event interpretation unit 121 may move coordinates (“location”) of the first user interface object 1211 to match coordinates of a touch point of the first user interface object 1211. The control unit 120 may animate the first user interface object 1211 to provide a visual interface indicating the touch event valid.

If the touch event is determined as valid, the object control unit 122 may change data group information, e.g., folder information, of the first user interface object 1211 to data group information, e.g., folder information, including the second user interface object 1221. The object control unit 122 may change a folder path of the first user interface object 1211.

The object control unit 122 may determine whether an execution of data processing involved in the folder path change is to be performed in a data cache or a data scanner, and if the data processing is determined to be performed, the object control unit 122 may generate a data processing request signal to request the data processing. The data processing unit 123 may control the data cache 130 to execute a series of procedures for changing path information stored in the data cache 130 in response to the received data processing request signal.

The data processing unit 123 may generate return information of the operation executed in response to the data processing request signal, and may transmit the generated return information to the object control unit 122. The object control unit 122 may receive the return information from the data processing unit 123, and may transmit callback information to the event interpretation unit 121 in response to the received return information.

The event interpretation unit 121 may update displaying of the user interface object in the at least one area in response to the received callback information.

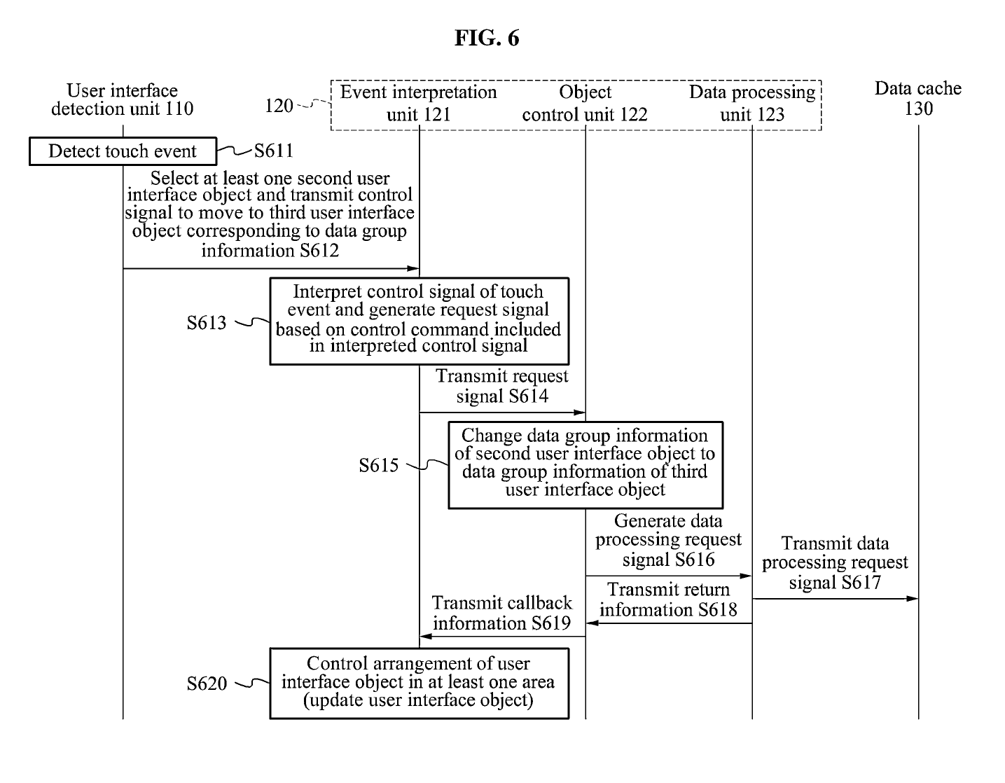

FIG. 6 is a flow diagram illustrating a method of controlling a mobile terminal according to another exemplary embodiment of the present invention.

Referring to FIG. 6, in operation S611, the user interface detection unit 110 may detect a touch event for a user interface object provided in at least one area on a display.

The areas displayed on the display may include a first area and a second area. The first area may include at least one first user interface object corresponding to data information or data group information placed on the clipboard, and the second area may include at least one second user interface object corresponding to data information or data group information stored in the mobile terminal. Further, the first area may display a folder object list by activating the folder object list in response to a predetermined or set input or a predetermined or set condition. For example, in response to a selection of multiple second user interface objects, the folder object list including at least one third user interface object corresponding to data group information, e.g., data folders, may be displayed in the first area. The third user interface object may correspond to a folder object in the folder object list displayed when the folder object list is activated in the first area. The folder object included in the folder object list may be a folder object representing a folder or a group to store categorized data for an executed application.

The first area may not display the clipboard for depositing one or more first user interface objects for temporal storage if the folder object list is activated. If the folder object list is deactivated, the clipboard may be displayed again in replacement of the folder object list. However, aspects are not limited thereto. The first area may display the clipboard along with the activated folder object list. Further, the folder object list may be a default setting and the clipboard may be activated in response to a predetermined or set condition or a predetermined touch input.

In operation S612, the user interface detection unit 110 may select the at least one second user interface object, and may transmit, to the event interpretation unit 121 of the control unit 120, the detected touch event including a control signal for moving the selected second user interface object to the third user interface object corresponding to data group information.

In operation S613, the event interpretation unit 121 of the control unit 120 may interpret a control signal of a second touch event in relation to the first touch event detected in an area, e.g., a location corresponding to a second user interface object in the second area, area on the display, and may generate a request signal in response to a control command included in the interpreted control signal.

In operation S614, the event interpretation unit 121 may transmit the generated request signal to the object control unit 122.

In operation S615, the object control unit 122 may receive the request signal from the event interpretation unit 121, and may perform a task from the control command for the user interface object in response to the request signal. The object control unit 122 may change data group information of the second user interface object to data group information of the third user interface object in response to the control command.

In operation S616, the object control unit 122 may determine whether data processing involved in the task is to be performed in a clipboard cache, data cache or a data scanner, and generate a data processing request signal to request the data processing if the data processing is determined to be performed.

In operation S617, the data processing unit 123 may receive the generated data processing request signal from the object control unit 122, and may execute an operation in response to the received data processing request signal. The data processing unit 123 may control the data cache 130 to execute a series of procedures for changing path information in response to the received data processing request signal in which the data cache 130 stores path information and/or header information of the user interface object placed on the clipboard.

In operation S618, the data processing unit 123 may generate return information of the operation corresponding to the data processing request signal, and may transmit the generated return information to the object control unit 122.

In operation S619, the object control unit 122 may receive the return information from the data processing unit 123, and may transmit callback information to the event interpretation unit 121 in response to the received return information.

In operation S620, the event interpretation unit 121 may control displaying of the user interface object in the at least one area in response to the received callback information.

Accordingly, a series of procedures for changing a data path may be executed through the touch event for moving the at least one second user interface object corresponding to data information or data group information included in the second area to the third user interface object corresponding to data group information placed in the first area.

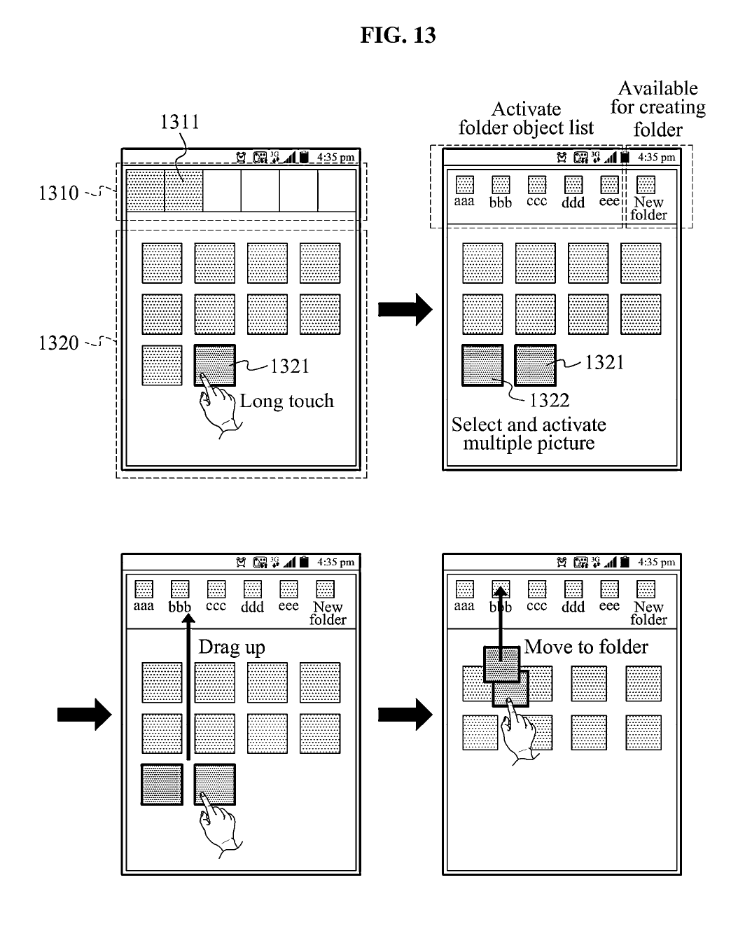

Hereinafter, an example of the method of FIG. 6 is described with reference to FIG. 13.

FIG. 13 is a diagram illustrating an example of the method of FIG. 6 according to an exemplary embodiment of the present invention.

Referring to FIG. 13, the display of the mobile terminal may include more than one area. The areas displayed on the display may be distinguished from one another, and may include a first area 1310 and a second area 1320. The first area 1310 may include at least one first user interface object 1311 corresponding to data information or data group information placed on the clipboard. The second area 1320 may include at least one second user interface object 1321 corresponding to data information or data group information included in the mobile terminal.

The first touch event may correspond to a selection signal for selecting the at least one second user interface object 1321 in the second area 1320, and the second touch event may correspond to a control signal for controlling the selected second user interface object 1321. For example, the first touch event may correspond to a touch event or touch action for touching and selecting the second user interface object 1321

As an example, the first touch event may correspond to a selection signal for selecting at least one second user interface object 1321 and 1322 by using a long touch. If a long touch is received for the second user interface object 1321, the second user interface object 1321 may remain selected after releasing the long touch. Then, the second user interface object 1322 may be selected by a subsequent touch after releasing the long touch for the second user interface object 1321, and the two second user interface objects 1321 and 1322 may be selected together. Further, a multi-touch input corresponding to the two second user interface objects 1321 and 1322 may be received for selecting the two second user interface objects 1321 and 1322. If multiple second user interface objects are selected, a folder object list may be activated in the first area 1310. The second touch event may correspond to a touch event or touch action for relocating the selected second user interface objects 1321 and 1322 and dragging and dropping the selected second user interface objects 1321 and 1322 to the third user interface object bbb in the activated folder object list.

The user interface detection unit 110 may detect an edit action for the user interface object detected from the touch input. The control unit 120 may interpret a control signal for the user interface object based on the touch event detected by the user interface detection unit 110, and may control the user interface object in the area in response to the interpreted control signal of the touch event.

For example, if an application being run in the mobile terminal corresponds to an image application, e.g., a gallery application of an Android-based phone, and the touch event corresponds to a path change event or a move action for dragging and dropping the second user interface object 1321 and 1322 corresponding to folder objects of the image application to the third user interface object bbb of the first area 1310 corresponding to a folder object, the control unit 120 may interpret and determine the touch event to be the path change event or the move action for selecting the second user interface objects 1321 and 1322 and dragging and dropping the selected second user interface objects 1321 and 1322, and may control displaying of the user interface object in response to the path change event or the move action.

Although not shown in FIG. 13, the activation of the folder object list may be performed in response to a predetermined or set condition or a predetermined or set input. In an example, the folder object list may be activated in the first area by touching one or more second user interface objects. In this example, the clipboard may be displayed along with the folder object list in the first area or the folder object list may be provided without providing the clipboard in the first area. In another example, the folder object list may be activated if one or more second user interface objects are dragged into a certain direction. In this example, a long touch or a double tap for a second user interface object may correspond to copying the second user interface object into the clipboard.

Further, the folder object list may be displayed when at least one second user interface object is displayed in the second area as a thumbnail image. The folder object list may be displayed in the first area as a default setting, and the clipboard may be activated in the first area when a double tap or a long touch is received on at least one second user interface object.

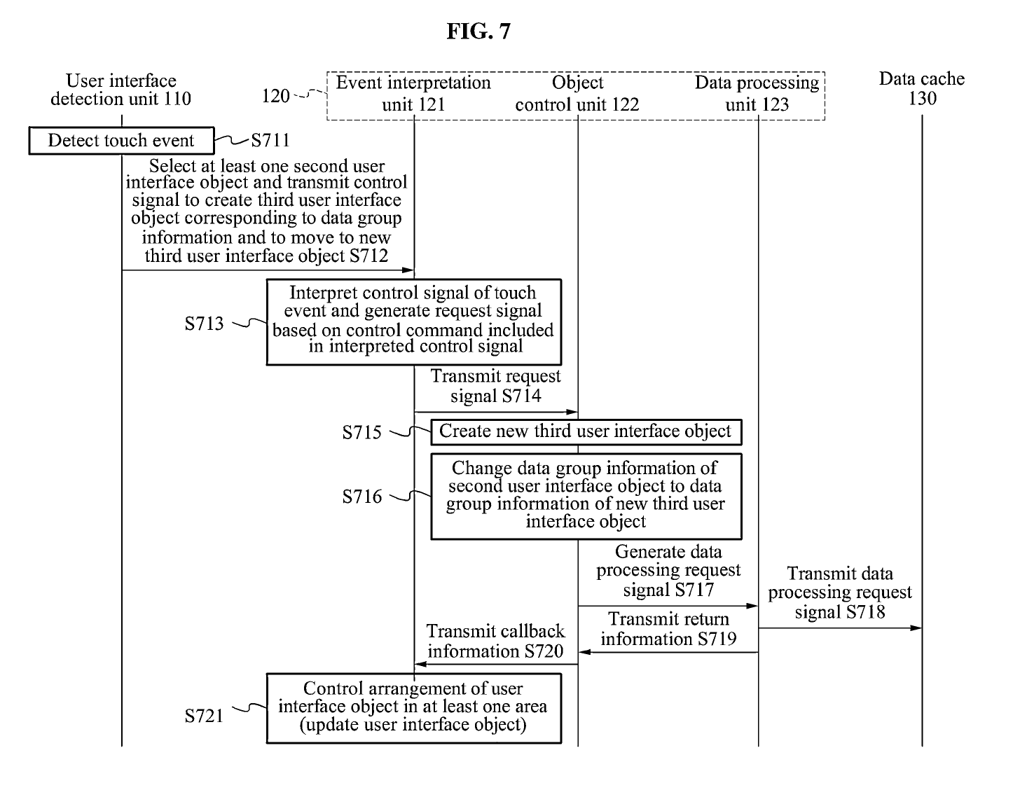

FIG. 7 is a flow diagram illustrating a method of controlling a mobile terminal according to another exemplary embodiment of the present invention.

Referring to FIG. 7, in operation S711, the user interface detection unit 110 may detect a touch event for a user interface object provided in at least one area on a display.

The areas displayed on the display may include a first area and a second area. The first area may include at least one first user interface object corresponding to data information or data group information placed on the clipboard, and the second area may include at least one second user interface object corresponding to data information or data group information stored in the mobile terminal.

In operation S712, the user interface detection unit 110 may select the at least one second user interface object in response to a detected touch input, and may transmit, to the event interpretation unit 121 of the control unit 120, the detected touch event including a control signal for creating a new third user interface object corresponding to data group information and for moving the selected second user interface object to the new third user interface object. A folder object list including a new folder creating tab may be activated in the first area in response to a predetermined or set input or a predetermined or set condition. The folder object list may further include one or more third user interface objects, e.g., existing folders or folders relating to the executed application. For example, in response to a selection of multiple second user interface objects, the folder object list may be activated in the first area.

In operation S713, the event interpretation unit 121 of the control unit 120 may interpret the control signal of the second touch event in relation to the first touch event detected in an area on the display, and may generate a request signal in response to a control command included in the interpreted control signal. The first touch event may correspond to a touch input for selecting multiple second user interface objects, and the second touch event may correspond to a drag input for moving the selected second user interface objects to a new third user interface object created in an activated folder object list activated in the first area.

In operation S714, the event interpretation unit 121 may transmit the generated request signal to the object control unit 122.

In operations S715 and S716, the object control unit 122 may receive the request signal from the event interpretation unit 121, and may perform a task from the control command for the user interface object in response to the request signal. The object control unit 122 may create a new third user interface object, and may change data group information of the second user interface object to data group information of the new third user interface object.

In operation S716, the object control unit 122 may determine whether data processing involved in the task from the control command is to be performed in a clipboard cache, data cache, or a data scanner, and if the data processing is determined to be performed, the object control unit 122 may generate a data processing request signal to request the data processing.

In operation S717, the data processing unit 123 may receive the generated data processing request signal from the object control unit 122, and may execute an operation corresponding to the received data processing request signal. In operation S718, The data processing unit 123 may control the data cache 130 to execute a series of procedures for changing path information in response to the received data processing request signal in which the data cache 130 stores path information and/or header information of the user interface object placed on the clipboard.

In operation S719, the data processing unit 123 may generate return information of the operation corresponding to the data processing request signal, and may transmit the generated return information to the object control unit 122.

In operation S720, the object control unit 122 may receive the return information from the data processing unit 123, and may transmit callback information to the event interpretation unit 121 in response to the received return information.

In operation S721, the event interpretation unit 121 may control displaying of the user interface object in the at least one area in response to the received callback information.

Accordingly, a series of procedures for changing a data path may be executed through the touch event for moving the new second user interface object corresponding to data information or data group information included in the second area to the third user interface object corresponding to data information or data group information placed in the clipboard of the first area.

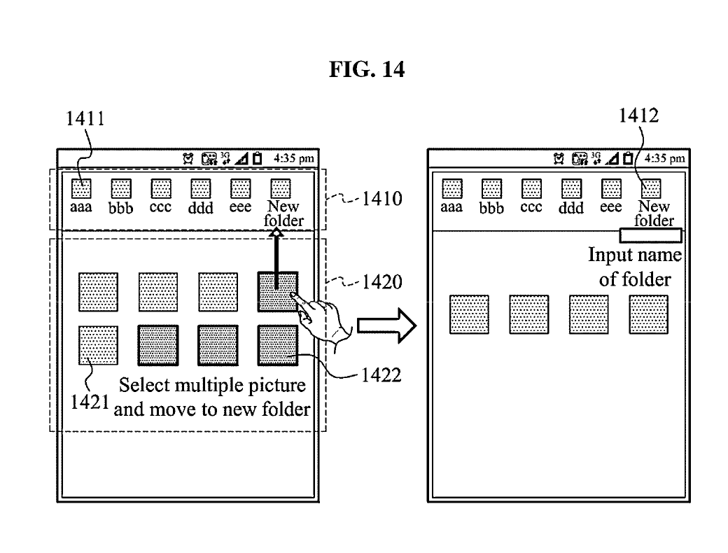

Hereinafter, an example of the method of FIG. 7 is described with reference to FIG. 14.

FIG. 14 is a diagram illustrating an example of the method of FIG. 7 according to an exemplary embodiment of the present invention.

Referring to FIG. 14, the display of the mobile terminal may include at least one area. The areas displayed on the display may be distinguished from one another, and may include a first area 1410 and a second area 1420. The first area 1410 may include at least one third user interface object 1411 corresponding to data group information in a folder object list. The second area 1420 may include at least one second user interface object 1421 and 1422 corresponding to data information or data group information stored in the mobile terminal.

The first touch event may correspond to a selection signal for selecting the at least one second user interface object 1422 in the second area 1420, and the second touch event may correspond to a control signal for controlling the selected second user interface object 1422. For example, the first touch event may correspond to a touch event or touch action for touching and selecting the at least one second user interface object 1422, and the second touch event may correspond to a touch event or a touch action for dragging and dropping the selected second user interface object 1422 to a new third user interface object 1412 available for creating a new folder.

The user interface detection unit 110 may detect an edit action for the user interface object detected from the touch input. The control unit 120 may interpret a control signal for the user interface object based on the touch event detected by the user interface detection unit 110, and may control the user interface object in the area in response to the interpreted control signal of the touch event.

For example, if an application being run in the mobile terminal corresponds to an image application, e.g., a gallery application of an Android-based phone, and the touch event corresponds to a folder create and path change event or a move action for dragging and dropping the second user interface object 1422 corresponding to a data object of the image application to the third user interface object 1412 of the first area 1410 corresponding to a new folder in the folder object list, the control unit 120 may interpret and determine the touch event as the folder create and path change event or the move action for selecting the second user interface object 1422 and dragging and dropping the selected second user interface object 1422 to the new folder 1412, and may control displaying of the user interface object in response to the folder create and path change event or the move action.

Accordingly, an interface may be provided through the apparatus for controlling a mobile terminal by creating the new folder 1412 as the new third user interface object in the folder object list of the first area 1410, by copying the second user interface object 1422, and by pasting the copied second user interface object 1422 into the new folder 1412 in response to the touch events.

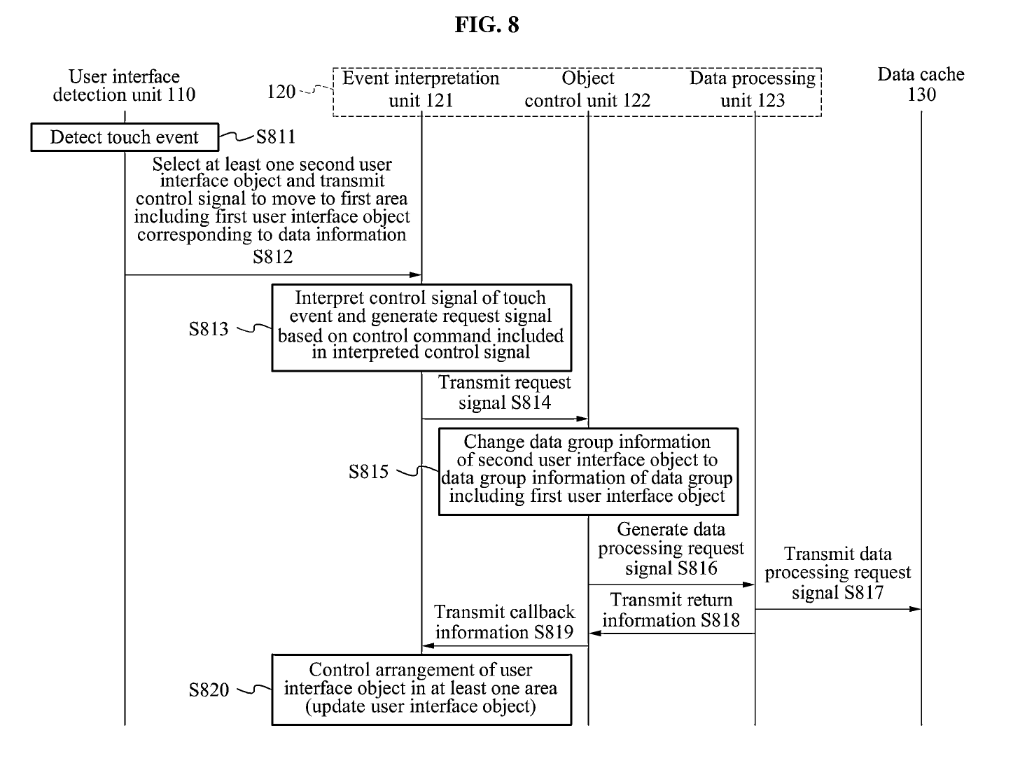

FIG. 8 is a flow diagram illustrating a method of controlling a mobile terminal according to another exemplary embodiment of the present invention.

The method of FIG. 8 is similar to that of FIG. 6 except operations S811 and S815. Accordingly, a description of the similar operation is omitted herein for conciseness and ease of description. In operation S811, the user interface detection unit 110 may detect a touch event for a user interface object provided in at least one area on a display. The areas displayed on the display may include a first area and a second area. The first area may include at least one first user interface object corresponding to data information placed on the clipboard, and the second area may include at least one second user interface object corresponding to data information or data group information included in the mobile terminal. In operation S815, the object control unit 122 may receive the request signal from the event interpretation unit 121, and may perform a task from the control command for the user interface object in response to the request signal. The object control unit 122 may change data group information of the second user interface object to data group information of a data group including the first user interface object in response to the control command.

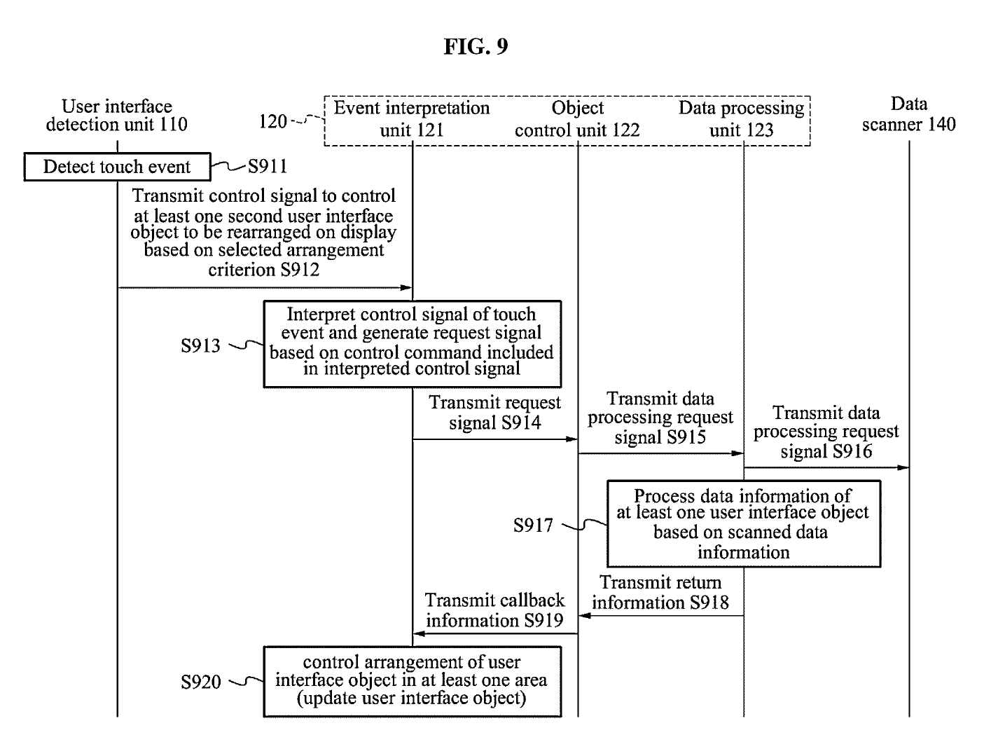

FIG. 9 is a flow diagram illustrating a method of controlling a mobile terminal according to another exemplary embodiment of the present invention.

Referring to FIG. 9, in operation S911, the user interface detection unit 110 may detect a touch event for a user interface object provided in at least one area on a display.

The areas displayed on the display may include a first area and a second area. The first area may include at least one first user interface object corresponding to data information or data group information placed on the clipboard, and the second area may include at least one second user interface object corresponding to data information or data group information stored in the mobile terminal.

In operation S912, the user interface detection unit 110 may transmit, to the event interpretation unit 121 of the control unit 120, the detected touch event including a control signal for selecting a criterion for re-arranging at least one user interface object on the display.

In operation S913, the event interpretation unit 121 of the control unit 120 may interpret the control signal of the touch event, and may generate a request signal in response to a control command included in the interpreted control signal.

In operation S914, the event interpretation unit 121 may transmit the generated request signal to the object control unit 122.

In operation S914 and S915, the object control unit 122 may receive the request signal from the event interpretation unit 121, and may perform a task from the control command for the user interface object in response to the received request signal. The object control unit 122 may determine whether data processing involved in the task from the control command is to be performed in a data cache or a data scanner, and if the data processing is determined to be performed, the object control unit 122 may generate a data processing request signal to request the data processing.

In operation S915 and S916, the data processing unit 123 may receive the generated data processing request signal from the object control unit 122, and may execute an operation corresponding to the received data processing request signal. The data processing unit 123 may control the data scanner 140 to scan data information included in the mobile terminal, in which the data scanner 140 scans data information and stores and maintains the scanned data information temporarily.

In operation S917, the data processing unit 123 may process data information of the at least one user interface object based on the scanned data information.

In operation S918, the data processing unit 123 may generate return information of the operation corresponding to the data processing request signal, and may transmit the generated return information to the object control unit 122.

For example, a process for implementing a data scanner connection in an Android-based mobile terminal is as follows:

```
public class SingleMediaScanner implements
MediaScannerConnectionClient {
public SingleMediaScanner(Context context, File f) { }
public void onMediaScannerConnected( ) {
        // connected
}
  public void onScanCompleted(String path, Uri uri) {
  // scan completed
  }
}
```

In operation S919, the object control unit 122 may receive the return information from the event interpretation unit 121, and may transmit callback information to the event interpretation unit 121 in response to the received return information.

In operation S920, the event interpretation unit 121 may control displaying of the user interface object in the at least one area in response to the callback information being received.

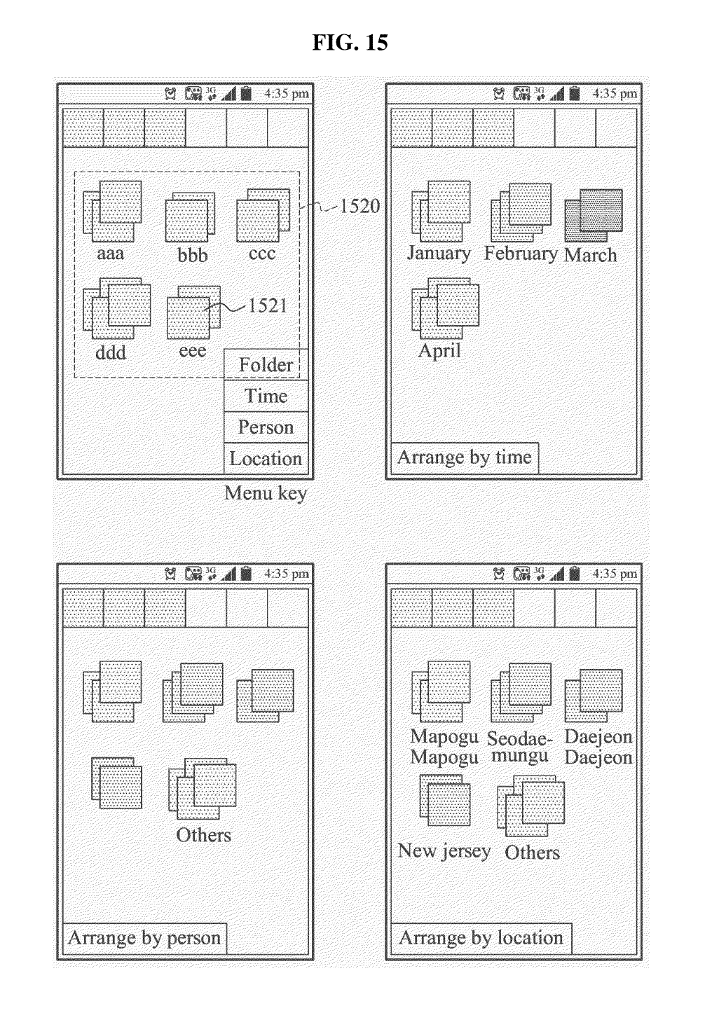

Hereinafter, an example of the method of FIG. 9 is described with reference to FIG. 15.

FIG. 15 is a diagram illustrating an example of the method of FIG. 9 according to an exemplary embodiment of the present invention.

Referring to FIG. 15, the first touch event may include a selection signal for selecting a criterion for re-arranging the user interface object included in at least one area on the display, and the second touch event may include a control signal for controlling re-arrangement of the user interface object included in the at least one area on the display based on the selected criterion.

For example, if an application being run in the mobile terminal corresponds to an image application, e.g., a gallery application of an Android-based phone or other computing devices, the touch event may include a control signal for selecting a predetermined criterion among one or more criteria for re-arranging second user interface objects 1521 in a second area 1520 and for re-arranging the second user interface objects 1521 based on the selected criterion.

The control unit 120 may re-arrange the user interface objects by the selected criterion, such as folder name, time, person, and location.

If the re-arrangement criterion is a folder name, the control unit 120 may classify images for each upper-level folder listed at the last on a path of image data included in data scanned by the data scanner 140. In a case of an Android-based phone, the control unit 120 may classify the images for each folder, for example, an upper-level folder “mypic” of “abc.jpg” on a path “mnt/sdcard/mypic/abc.jpg”.

If the re-arrangement criterion is time, the control unit 120 may re-arrange image data according to time data tag stored in each image data. Re-arrangement and grouping may be performed based on a monthly basis and the rearrangement results may be provided on the display as shown in upper-right figure of FIG. 15. Re-arrangement and grouping may be performed based on a yearly basis, a weekly basis, a biweekly basis, and the like and the rearrangement results may be provided on the display.

If the re-arrangement criterion is person, the control unit 120 may determine whether the same person is included in image files through image processing, and may re-arrange the image files based on the determined result. Image files including the same person may be grouped in the same group. The control unit 120 may classify an image including an unrecognizable person into a category “other files”. If multiple persons are included in an image, the control unit 120 may categorize the image into each group corresponding to a person included in the image. Further, the control unit 120 may arrange the images including multiple persons into a group corresponding to the most frequently recognized person among the included multiple persons. The control unit 120 may group the images by, for example, a person A, a person B, and the like. Further, if an image includes person A and person B, the control unit 120 may categorize the image in to a group including person A and person B.

If the re-arrangement criterion is location, the control unit 120 may re-arrange images according to the Geo-tag data stored in the images. In an example, if Geo-tag data is in proximity to a region corresponding to a global positioning system (GPS)-based location of the mobile terminal, the control unit 120 may re-arrange the images by segmenting groups into geographically smaller areas. Specifically, if the GPS-based location of the mobile terminal is Country A, smaller regions of Country A may be segmented and images may be categorized according to the smaller regions. However, images taken from other countries may be grouped by each country. Re-arrangement by city or country may be possible based on a user setting or a menu selection.

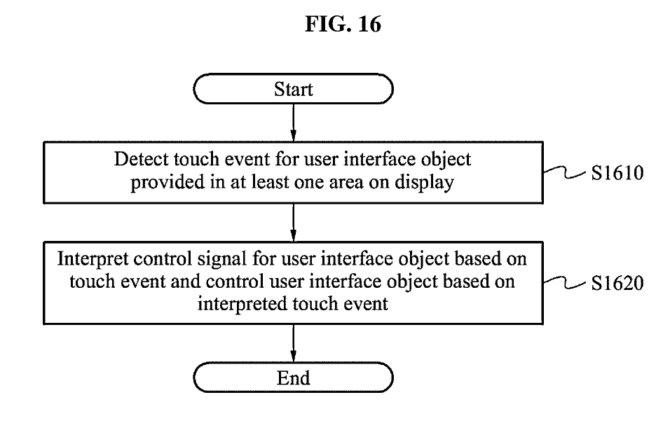

FIG. 16 is a flowchart illustrating a method of controlling a mobile terminal according to an exemplary embodiment of the present invention.

Referring to FIG. 16, in operation S1610, the mobile terminal may receive a touch input and detect a touch event, e.g., an edit action, for the user interface object determined from the touch input.

In operation S1620, the mobile terminal may interpret a control signal for the user interface object based on the detected touch event, and may control the user interface object in the at least one area in response to the interpreted control signal of the touch event.

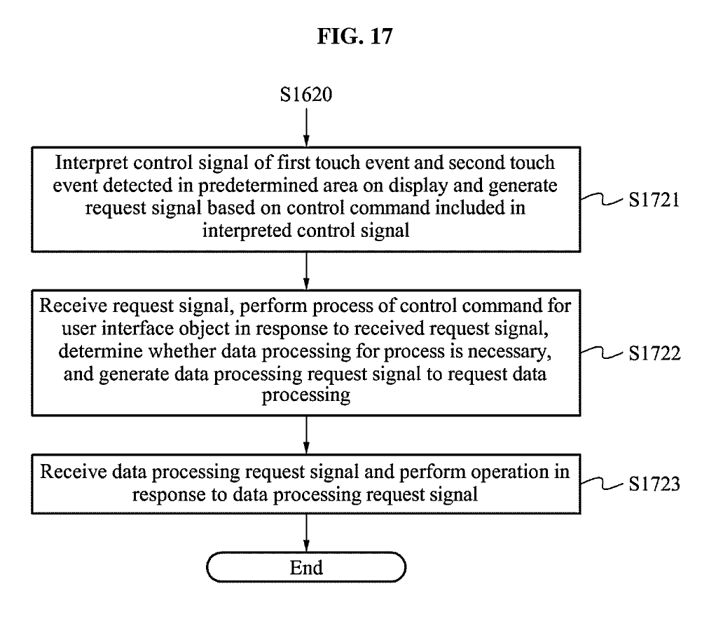

FIG. 17 is a flowchart illustrating a method of controlling a user interface object of a mobile terminal according to an exemplary embodiment of the present invention.

Referring to FIG. 17, in operation S1721, the mobile terminal may interpret a control signal of a first touch event and a second touch event detected in a predetermined or set area on a touch input display, and may generate a request signal in response to a control command included in the interpreted control signal.

In operation S1722, the mobile terminal may receive the request signal, may perform a task from the control command for the user interface object in response to the request signal, may determine whether data processing involved in the task from the control command is to be performed, and may generate a data processing request signal to request the data processing.

In operation S1723, the mobile terminal may receive the data processing request signal, and may execute an operation corresponding to the received data processing request signal.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard discs, floppy discs, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to aspects of the present invention, editing of data files and folders in the mobile terminal may be performed using simpler manipulation inputs.

Also, aspects of the present invention may provide a method for controlling a mobile terminal that may enable folder editing through a touch-based operation.

Further, aspects of the present invention may provide a method for controlling a mobile terminal that may provide an interface for providing a list of data files or folders to be edited more efficiently.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for providing a user interface for data management, the method comprising:
displaying an application screen comprising a first area and a second area on a touch screen display, the first area being configured to display a folder object list comprising a folder object;
displaying a user interface object in the second area;
receiving a touch input to relocate the user interface object to the first area;
in response to a determination that the touch input corresponds to a touch event for relocating the user interface object to the folder object in the folder object list, changing path information of the user interface object to associate with the folder object.

2. The method of claim 1, wherein the folder object list is displayed in the first area in response to a selection of multiple user interface objects displayed in the second area.

3. The method of claim 1, wherein the folder object list comprising multiple folder objects configured to be scrolled in response to a touch input for scrolling the folder objects.

4. The method of claim 1, wherein the first area displays a new folder object for creating a new folder to store the user interface object in the new folder.

5. The method of claim 4, further comprising:
in response to a touch input for relocating the user interface object to the new folder, providing a touch input interface for naming the new folder.

6. The method of claim 1, further comprising:
executing an application;
identifying one or more folder objects to be displayed in the first area for the executed application; and
generating the folder object list, the folder object list comprising the identified folder objects.

7. The method of claim 1, further comprising:
sorting data of an application into multiple groups categorized by a selected criterion, the multiple groups corresponding to user interface objects displayed in the second area.

8. The method of claim 7, wherein the criterion comprises at least one of a folder name, a time period, a person, and a location.

9. A method for providing a user interface for data management, comprising:
displaying an application screen comprising a first area and a second area on a touch screen display, the first area being configured to display a clipboard for depositing a first user interface object or to display a folder object list comprising a folder object;
displaying a second user interface object in the second area;
receiving a touch input to relocate the second user interface object to the first area;
in response to a determination that the touch input corresponds to a touch event for depositing the second user interface object in the clipboard, depositing the second user interface object in the clipboard as a first user interface object; and
in response to a determination that the touch input corresponds to a touch event for relocating the second user interface object to the folder object in the folder object list, changing path information of the second user interface object to associated with the folder object.

10. The method of claim 9, wherein the touch event for relocating the second user interface object to the folder object in the folder object list is configured to occur in response to a selection of multiple second user interface objects displayed in the second area.

11. The method of claim 9, wherein the folder object list comprises multiple folder objects configured to be scrolled in response to a touch input for scrolling the folder objects.

12. The method of claim 9, wherein the first area displays a new folder object for creating a new folder to store the second user interface object in the new folder.

13. The method of claim 12, further comprising:
in response to a determination that the touch input corresponds to a touch event for relocating the second user interface object to the new folder, providing a touch input interface for naming the new folder.

14. The method of claim 9, further comprising:
executing an application;
identifying one or more folder objects to be displayed in the first area for the executed application; and
generating the folder object list, the folder object list comprising the identified folder objects.

15. The method of claim 9, further comprising:
sorting data of an application into multiple groups categorized by a selected criterion, the multiple groups corresponding to second user interface objects displayed in the second area.

16. The method of claim 15, wherein the criterion comprises at least one of a folder name, a time period, a person, and a location.

17. The method of claim 9, further comprising:
receiving a touch input to relocate the first user interface object in the clipboard to the second user interface object; and
relocating the first user interface object in the second user interface object.

18. The method of claim 9, further comprising:
receiving a touch input to relocate the first user interface object in the clipboard to the second area other than the second user interface object; and
relocating the first user interface object to a new folder in the second area.

19. A non-transitory computer readable storage medium storing one or more programs for instructing a computer, when executed by a processor, to perform the method of claim 1.

20. An apparatus to provide a user interface for data management, comprising:
a touch screen display to display an application screen comprising a first area and a second area, the first area being configured to display a folder object list comprising a folder object, to display a user interface object in the second area, and to receive a touch input to relocate the user interface object to the first area; and
a processor configured to change path information of the user interface object to associate with the folder object in response to a determination that the touch input corresponds to a touch event for relocating the second user interface object to the folder object.

21. The apparatus of claim 20, wherein the folder object list is displayed in the first area in response to a set condition to display the folder object list.
